(19) United States
(12) Patent Application Publication
(10) Pub. No.: US 2022/0300989 A1
(43) Pub. Date: Sep. 22, 2022

(54) STORE SYSTEM AND METHOD

(71) Applicant: TOSHIBA TEC KABUSHIKI KAISHA, Tokyo (JP)

(72) Inventor: Daisuke MIYAGI, Fuji Shizuoka (JP)

(73) Assignee: TOSHIBA TEC KABUSHIKI KAISHA, Tokyo (JP)

(21) Appl. No.: 17/546,348

(22) Filed: Dec. 9, 2021

(30) Foreign Application Priority Data
Mar. 19, 2021 (JP) 2021-045531

(51) Int. Cl. G06Q 30/02; G06V 40/20; G06V 40/10; G06V 20/52; G06T 7/20; G06T 7/70

(52) U.S. Cl. CPC G06Q 30/0201; G06V 40/25; G06V 40/10; G06V 20/52; G06T 7/20; G06T 7/70; G06T 2207/30196; G06T 2207/30232; G06T 2207/30241

(57) ABSTRACT

A store system includes a processor. The processor is configured to detect movement of individual merchandise sold in a store, acquire a date and time when the movement of the merchandise is detected, determine a person related to the movement of the merchandise whose movement is detected, and store in a memory, for the individual merchandise, the date and time and information on the determined person as the movement detected at the date and time in association with each other.

### CROSS-REFERENCE TO RELATED APPLICATION

This application is based upon and claims the benefit of priority from Japanese Patent Application No. 2021-045531, filed on Mar. 19, 2021, the entire contents of which are incorporated herein by reference.

### FIELD

Embodiments described herein relate generally to a store system and a method for causing a computer to implement a function as the store system.

### BACKGROUND

A technique is known for creating moving line data of a shopper moving in a store. Similarly, a technique is known for creating the moving line data of a merchandise that moves in the store together with the shopper. Since a movement trajectory of the merchandise can be recognized together with a movement trajectory of the shopper by analyzing the moving line data, it is easy to acquire information on a route through which the shopper purchases the merchandise, for example.

However, for example, for each merchandise displayed on a merchandise shelf, it is difficult to grasp information that the shopper takes the merchandise but does not purchase the merchandise and returns the merchandise to the merchandise shelf.

### DESCRIPTION OF THE DRAWINGS

FIG. 1 is a schematic configuration diagram of a store system according to an example embodiment;

FIG. 2 is a block diagram showing a functional configuration of a person tracking device;

FIG. 3 is a schematic diagram showing main items of data stored in a moving line file;

FIG. 4 is a block diagram showing a functional configuration of a shelf monitoring device;

FIG. 5 is a front view showing an example of a merchandise shelf;

FIG. 6 is a schematic diagram showing main items of data stored in a facing person file;

FIG. 7 is a block diagram showing a functional configuration of a transaction processing device;

FIG. 8 is a schematic diagram showing main items of data stored in a transaction file;

FIG. 9 is a block diagram showing a functional configuration of an individual product management device;

FIG. 10 is a schematic diagram showing a configuration of a movement history table;

FIG. 11 is a schematic diagram showing main items of data stored in an individual product management file;

FIG. 12 is a flowchart showing a procedure of information processing executed by a control unit of the person tracking device;

FIG. 13 is a flowchart showing a procedure of information processing executed by a control unit of the shelf monitoring device;

FIG. 14 is a flowchart showing a procedure of information processing executed by a control unit of the transaction processing device;

FIG. 15 is a flowchart showing a procedure of information processing executed by a control unit of the individual product management device;

FIG. 16 is a flowchart showing a main procedure of event determination; and

FIG. 17 is a flowchart showing a main procedure of final event determination.

### DETAILED DESCRIPTION

In general, according to at least one embodiment, a store system capable of managing whether there is a history that a person takes a merchandise is provided.

A store system according to at least one embodiment includes: a movement detection unit (e.g., a movement detection device), a date and time acquisition unit (e.g. a date and time acquisition device), a person specifying unit (e.g., a person specifying device), and a storage unit (e.g., a storage device, a memory). The movement detection unit detects movement of individual merchandise sold in a store. The date and time acquisition unit acquires a date and time when the movement of the merchandise is detected by the movement detection unit. The person specifying unit specifies (e.g., determines) a person related to the movement of the merchandise whose movement is detected by the movement detection unit. The storage unit stores, for the individual merchandise, the date and time acquired by the date and time acquisition unit and information on the person specified as the movement detected at the date and time by the person specifying unit in association with each other.

Hereinafter, at least one embodiment of a store system will be described with reference to the drawings.

At least one embodiment exemplifies a store system constructed in a store of a self-registration method using a user terminal. The self-registration method is a method in which when a merchandise to be purchased by a shopper is put in a shopping basket, the user terminal is operated to self-register merchandise data.

[Description of Configuration of Store System]

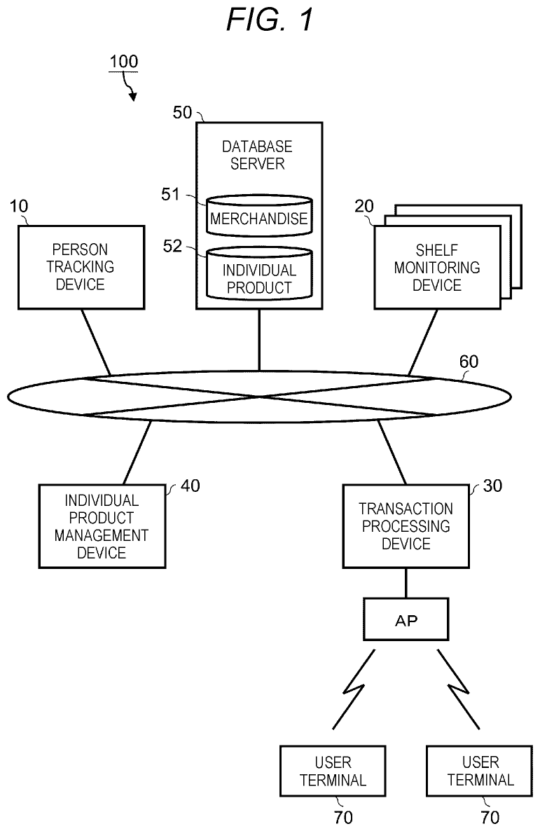

FIG. 1 is a schematic configuration diagram of a store system 100 according to at least one embodiment. The store system 100 includes a person tracking device 10, a shelf monitoring device 20, a transaction processing device 30, an individual product management device 40, a database server 50, and a communication network 60. The store system 100 connects the person tracking device 10, the shelf monitoring device 20, the transaction processing device 30, the individual product management device 40, and the database server 50 via the communication network 60. The communication network 60 is typically a local area network (LAN). The LAN may be a wired LAN or a wireless LAN. The communication network 60 may be, for example, the Internet or a network constructed by applying a technique of the Internet.

The database server 50 manages a merchandise database 51 and an individual product database 52.

The merchandise database 51 collectively stores merchandise data generated for each item of each merchandise sold in the store. The merchandise data includes items such as a merchandise code, a merchandise name, and a price. The merchandise code is identification information for identifying each merchandise in units of items. A barcode representing the merchandise code is attached to each merchandise.

The individual product database 52 collectively stores individual product data generated for each individual product of the merchandise. The individual product data includes items such as an individual product ID and the merchandise code. The individual product ID is identification information for identifying each merchandise in units of individual products. A wireless tag is attached to each merchandise. The wireless tag is a wireless communication medium in which unique radio frequency identification (RFID) is stored in an IC memory. The RFID is different for each wireless tag. Therefore, the merchandise to which the wireless tag is attached is identified in units of individual products by the RFID of the wireless tag. Therefore, in at least one embodiment, the RFID of the wireless tag attached to the merchandise is taken as the individual product ID of the merchandise. The wireless tag can read the RFID stored in the IC memory in a non-contact manner by using a dedicated reader.

The store system 100 enables user terminals 70 to be used. The user terminal 70 is used by a consumer who performs shopping in a store, that is, the so-called shopper. The user terminal 70 has at least a barcode scanning function and information display function. The user terminal 70 has a wireless communication function, relays an access point AP disposed in the store, and performs data communication with the transaction processing device 30. The user terminal 70 is, for example, a dedicated terminal attached to a shopping cart used in the store. If an application program for implementing the above described functions is implemented, it is also possible to use a smartphone, a tablet terminal, or the like owned by the shopper as the user terminal 70.

[Description of Person Tracking Device]

The person tracking device 10 is a device for tracking a moving line of a person moving in the store. The person is not limited to the shopper. The person also includes a clerk who carries out work such as putting out merchandise on the merchandise shelf and collecting the merchandise.

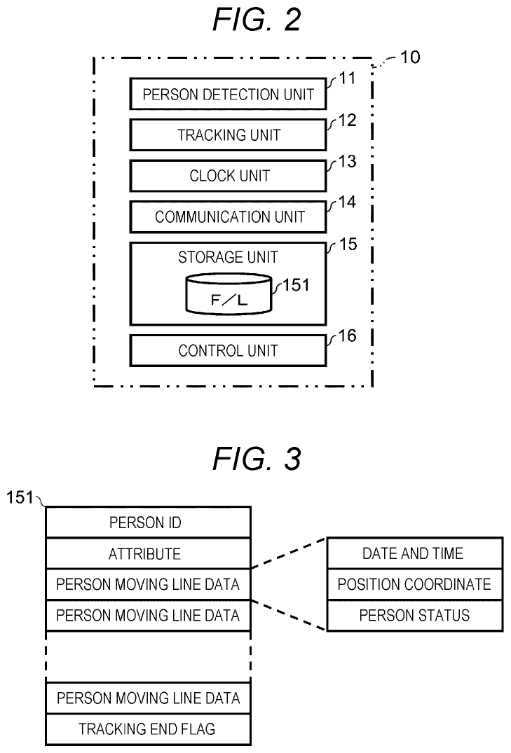

FIG. 2 is a block diagram showing a functional configuration of the person tracking device 10. The person tracking device 10 has functions as a person detection unit 11 (e.g., a detection device), a tracking unit 12 (e.g., a tracking device, a tracker), a clock unit 13 (e.g., a clock), a communication unit 14 (e.g., a communication device), a storage unit 15 (e.g., a storage device, a memory), and a control unit 16 (e.g., a controller).

The person detection unit 11 detects a position of the person moving in the store by a plurality of sensors disposed in the store. The person detection unit 11 can simultaneously detect positions of a plurality of persons. As the sensor, a well-known camera sensor such as an optical camera, an infrared camera, a time of flight (TOF) camera, or a stereo camera may be used. The position of the person may be detected by using a transmitter and a receiver of a beacon as the sensors.

The tracking unit 12 tracks the moving line of the person moving in the store based on position information of each person detected by the person detection unit 11.

The clock unit 13 tracks a date and time.

The communication unit 14 is connected to the communication network 60. The communication unit 14 performs data communication with another device connected to the communication network 60 in accordance with a predetermined communication protocol.

The storage unit 15 includes a nonvolatile memory area and a volatile memory area. The storage unit 15 stores a control program for controlling an operation of the person tracking device 10 in the nonvolatile memory area. The storage unit 15 stores data necessary for operating as the person tracking device 10 in the volatile memory area. The nonvolatile memory area is, for example, a read only memory (ROM). The volatile memory area is, for example, a random access memory (RAM).

The control unit 16 controls the person detection unit 11, the tracking unit 12, the clock unit 13, the communication unit 14, and the storage unit 15 in accordance with the control program. The control unit 16 mainly includes a processor. The processor is, for example, a central processing unit (CPU) (e.g., a central processor).

The person tracking device 10 sets a part of the volatile memory area of the storage unit 15 as an area of a moving line file 151. The moving line file 151 is an area for storing the data of the moving line to be tracked by the tracking unit 12 for each person detected by the person detection unit 11.

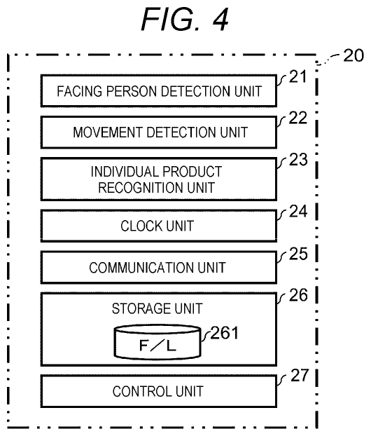

FIG. 3 is a schematic diagram showing main items of data stored in the moving line file 151. The moving line file 151 stores a person ID, an attribute, a plurality of pieces of person moving line data, and a tracking end flag. The person ID is a unique code assigned to individually identify the person detected by the person detection unit 11. The person ID is set by the person detection unit 11. The person ID may be set by the tracking unit 12.

The attribute is information indicating an attribute of the person. The attribute includes the shopper and the clerk. The attribute is determined by the person detection unit 11. For example, the clerk wears a uniform specified in the store. When the person detected by analysis of an image obtained by the camera sensor wears a uniform, the person detection unit 11 determines the attribute of the person as the clerk. When the person detected by the analysis of the image does not wear the uniform, the person detection unit 11 determines the attribute of the person as the shopper. When a beacon ID received by the receiver is an ID for the clerk, the person detection unit 11 may determine the attribute of the person as the clerk, and when the ID is not the ID for the clerk, the person detection unit 11 may determine the attribute of the person as the shopper.

The person moving line data is data including date and time, position information, and a person status. The person moving line data may include information other than the date and time, the position information, and the person status. The date and time is a date and time clocked by the clock unit 13 at a time point when the person identified by the person ID is detected by the person detection unit 11. The position information is a coordinate indicating a position of the person in the store when the person is detected at the date and time. A position coordinate is a three-dimensional coordinate in which any point in the store is defined as an origin and a distance from the origin is represented three-dimensionally in an X-axis direction, a Y-axis direction, and a Z-axis direction. The three-dimensional coordinate is calculated by the tracking unit 12. The three-dimensional coordinate may be calculated by the control unit 16. The person status represents a state of the person identified by the person ID. The state includes a moving state in which the person is moving in the store and a stationary state in which the person stays without moving.

In the moving line file 151, the person moving line data is stored in time series until the person identified by the person ID is not detected after being detected by the person detection unit 11. The tracking end flag is 1-bit data to be set when the tracking of the person identified by the person ID ends. In at least one embodiment, when the person identified by the person ID is no longer detected by the person detection unit 11, the tracking is ended.

[Description of Shelf Monitoring Device]

The shelf monitoring device 20 is a device for monitoring movement of the merchandise displayed on the merchandise shelf and an action of the person facing the merchandise shelf. The shelf monitoring device 20 is provided for each merchandise shelf. In one merchandise shelf, one or more merchandises are displayed. Each merchandise is provided with a wireless tag for individual product identification.

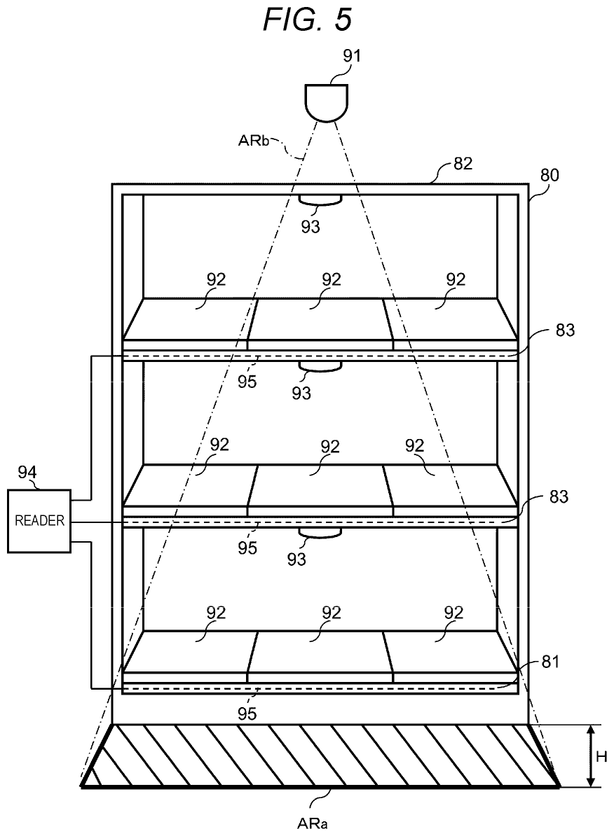

FIG. 4 is a block diagram showing a functional configuration of the shelf monitoring device 20. FIG. 5 is an example of a merchandise shelf 80 provided with the shelf monitoring device 20. FIG. 5 shows a state in which the merchandise shelf 80 having a three-stage configuration in which a space between a bottom plate 81 and a top plate 82 is partitioned by two shelf plates 83 is viewed from a front surface. The front surface is a surface on a side on which the merchandise is taken in and out of the merchandise shelf 80. Each stage of the merchandise shelf 80 is divided into three sections at the left and right and the center, and basically, one item of merchandise is displayed in one section. One item of merchandise may be displayed over a plurality of sections. It is not intended to prevent a plurality of items of merchandises from being displayed in one section.

The shelf monitoring device 20 has functions as a facing person detection unit 21 (e.g., a facing person detection device), a movement detection unit 22 (e.g., a movement detection device), an individual product recognition unit 23 (an individual product recognition device), a clock unit 24 (e.g., a clock), a communication unit 25 (e.g., a communication device), a storage unit 26 (e.g., a storage device, a memory), and a control unit 27 (e.g., a controller).

The facing person detection unit 21 detects a person facing the front surface of the merchandise shelf. As shown in FIG. 5, in at least one embodiment, of a floor surface on the front surface side of the merchandise shelf 80, a section having a width H from an edge of the merchandise shelf 80 is referred to as a monitoring target area ARa. In the monitoring target area ARa, only one person can stop. A camera sensor 91 for detecting the person located in the monitoring target area ARa is attached to an upper side of the merchandise shelf 80, for example, on a ceiling. The camera sensor 91 detects that the person is present in the monitoring target area ARa by reflecting the person in an imaging area ARb. The camera sensor 91 is a TOF camera, a stereo camera, or a 2D camera. By using the TOF camera, the stereo camera, or the 2D camera as the camera sensor 91, a skeleton of the person located in the monitoring target area ARa can be estimated, and the action of the person can be detected from the movement of the skeleton. Specifically, it is possible to detect an action in which the person bends in front of the merchandise shelf 80, an action in which an arm portion is extended toward the merchandise shelf 80, an action in which the arm portion is pulled back from the merchandise shelf 80, and the like.

The movement detection unit 22 detects movement of the merchandise displayed on the merchandise shelf 80. As shown in FIG. 5, in at least one embodiment, weight sensors 92 are respectively disposed on surfaces in the sections of the merchandise shelf 80 on which the merchandises are placed. The weight sensor 92 measures a total weight of the merchandises displayed in the section. The movement detection unit 22 detects that the merchandise is moved due to a change in the total weight measured by the weight sensor 92. Specifically, when the total weight fluctuates in an increasing direction, the movement detection unit 22 detects that the merchandise is placed on the merchandise shelf 80. When the total weight fluctuates in a decreasing direction, the movement detection unit 22 detects that the merchandise is taken out from the merchandise shelf 80.

A camera sensor 93 is attached to each stage of the merchandise shelf 80. The camera sensor 93 is, for example, an optical camera or an infrared camera, and is used for monitoring the merchandise displayed in each stage. As long as the merchandise can be monitored, an attachment position of the camera sensor is not particularly limited. Although FIG. 5 shows an example in which one camera sensor 93 is disposed for each stage, the number of the camera sensors 93 is not particularly limited. For example, the camera sensor 93 may be disposed for each section of each stage. The movement detection unit 22 may detect the movement of the merchandise by analyzing an image of the camera sensor 93. Alternatively, the movement detection unit 22 may detect the movement of the merchandise by using information on the total weight measured by the weight sensor 92 and information obtained by analyzing the image of the camera sensor 93 in combination.

The individual product recognition unit 23 recognizes the individual product ID of the merchandise whose movement is detected by the movement detection unit 22. As shown in FIG. 5, antennas 95 of a wireless tag reader 94 are respectively embedded in the stages of the merchandise shelf 80. The wireless tag reader 94 has a function of reading an RFID from the wireless tag communicating with the antenna 95 in a non-contact manner. An output level of the antenna 95 is set so as to enable non-contact communication with the wireless tags attached to all the merchandises displayed in the stage in which the antenna 95 is embedded. When it is detected by the movement detection unit 22 that the merchandise is placed on the merchandise shelf 80, the individual product recognition unit 23 recognizes the RFID which is newly read as the individual product ID of the merchandise placed on the merchandise shelf 80. When it is detected by the movement detection unit 22 that the merchandise is taken out from the merchandise shelf 80, the individual product recognition unit 23 recognizes the RFID which cannot be read as the individual product ID of the merchandise taken out from the merchandise shelf 80.

The clock unit 24 tracks the date and time.

The communication unit 25 is connected to the communication network 60. The communication unit 25 performs the data communication with another device connected to the communication network 60 in accordance with the predetermined communication protocol.

The storage unit 26 includes a nonvolatile memory area and a volatile memory area. The storage unit 26 stores a control program for controlling the operation of the shelf monitoring device 20 in the nonvolatile memory area. The storage unit 26 stores data necessary for operating as the shelf monitoring device 20 in the volatile memory area. The nonvolatile memory area is, for example, the ROM. The volatile memory area is, for example, the RAM.

The control unit 27 controls the facing person detection unit 21, the movement detection unit 22, the individual product recognition unit 23, the clock unit 24, the communication unit 25, and the storage unit 26 in accordance with the control program. The control unit 27 mainly includes a processor. The processor is, for example, the CPU.

The shelf monitoring device 20 sets a part of the volatile memory area of the storage unit 26 as an area of a facing person file 261. The facing person file 261 is an area for storing the data of the merchandise moved by the person, for each person facing the front surface of the merchandise shelf 80.

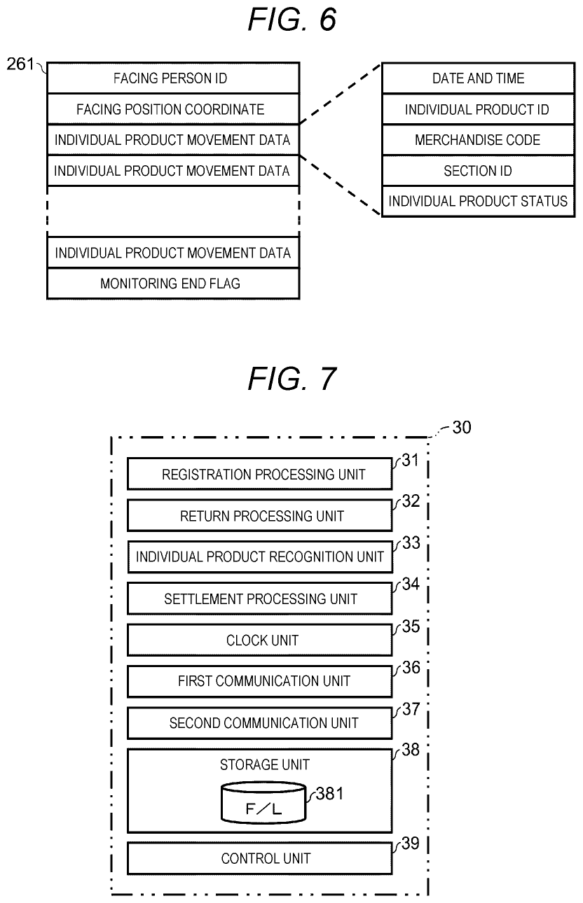

FIG. 6 is a schematic diagram showing main items of data stored in the facing person file 261. The facing person file 261 stores a facing person ID, a facing position coordinate, at least one piece of individual product movement data, and a monitoring end flag. The facing person ID is a unique code assigned to individually identify the person detected by the facing person detection unit 21. The facing person ID is set by the facing person detection unit 21.

The facing position coordinate is a coordinate indicating a position in the monitoring target area ARa of the person detected by the facing person detection unit 21. The facing position coordinate is a two-dimensional coordinate in which any point in the store is defined as an origin and a distance from the origin is two-dimensionally represented in the X-axis direction and the Y-axis direction in the same manner as the position coordinate related to the person moving line data. The two-dimensional coordinate is calculated by the facing person detection unit 21. The facing position coordinate may be a three-dimensional coordinate including a height direction from a floor surface as a Z-axis direction.

The individual product movement data is data including the date and time, the individual product ID, the merchandise code, the section ID, and an individual product status. The individual product movement data may include information other than the date and time, the individual product ID, the merchandise code, the section ID, and the individual product status. The date and time is the date and time clocked by the clock unit 24 at the time point when the movement of the merchandise is detected by the movement detection unit 22. The individual product ID is an RFID of a wireless tag attached to the merchandise whose movement is detected. The merchandise code is a merchandise code of the merchandise whose movement is detected. The section ID is a section ID of a section in which the movement of the merchandise is detected by the movement detection unit 22. In each section of the merchandise shelf 80, a unique section ID is set in advance as identification information for individually identifying sections. The individual product status indicates a state of the merchandise whose movement is detected. The state includes a taken-out state in which the merchandise is taken out from the merchandise shelf 80 and a placement state in which the merchandise is placed on the merchandise shelf 80.

In the facing person file 261, the individual product movement data related to the movement is stored in time series every time the merchandise is moved in the merchandise shelf 80 facing the person until the person detected by the facing person detection unit 21 goes out of the monitoring target area ARa. The monitoring end flag is 1-bit data to be set when the monitoring of the person identified by the facing person ID ends. In at least one embodiment, when the person identified by the facing person ID goes out of the monitoring target area ARa and is no longer detected by the facing person detection unit 21, the monitoring ends.

[Description of Transaction Processing Device]

The transaction processing device 30 creates a list of merchandise purchased by the shopper, a so-called purchase list, and settles transaction with the shopper based on data of the purchase list.

FIG. 7 is a block diagram showing a functional configuration of the transaction processing device 30. The transaction processing device 30 has functions as a registration processing unit 31 (e.g., a registration processor), a return processing unit 32 (e.g., a return processor), an individual product recognition unit 33 (e.g., an individual product recognition device), a settlement processing unit 34 (e.g., a settlement processor), a clock unit 35 (e.g., a clock), a first communication unit 36 (e.g., a first communication device), a second communication unit 37 (e.g., a second communication device), a storage unit 38 (e.g., a storage device, a memory), and a control unit 39 (e.g., a controller).

The registration processing unit 31 executes processing for registering sales data of the merchandise purchased by the shopper from the merchandise shelf 80 in the purchase list. For example, when the barcode of the merchandise is scanned in the user terminal 70, the registration processing unit 31 searches the merchandise database 51 with the merchandise code obtained from the barcode. Then, the registration processing unit 31 acquires the merchandise data including the merchandise code from the merchandise database 51, generates the sales data based on the merchandise data, and registers the sales data in the purchase list.

The return processing unit 32 executes processing for erasing the sales data of the merchandise returned to the merchandise shelf 80 by the shopper from the purchase list. For example, when the barcode of the merchandise is scanned after a return operation in the user terminal 70, the return processing unit 32 deletes the sales data including the merchandise code obtained from the barcode from the purchase list.

The individual product recognition unit 33 executes processing for recognizing the individual product ID of the merchandise purchased by the shopper from the merchandise shelf 80 or the merchandise returned to the product shelf 80 by the shopper. When the shopper purchases the merchandise taken out of the merchandise shelf 80, the shopper scans the barcode of the merchandise with the user terminal 70 and then puts the merchandise into the shopping basket. Therefore, the individual product recognition unit 33 recognizes the individual product ID included in the individual product movement data of a past date and time closest to a current date and time among the individual product movement data including the merchandise code of the scanned barcode as the individual product ID of the merchandise purchased by the shopper from the merchandise shelf 80. When the scanned merchandise is returned to the merchandise shelf 80 in order to return the merchandise, the shopper performs the return operation in the user terminal 70, and then scans the barcode of the merchandise with the user terminal 70 and returns the merchandise to the merchandise shelf 80. Therefore, the individual product recognition unit 33 recognizes, as the individual product ID of the merchandise returned to the merchandise shelf 80 by the shopper, the individual product ID included in the individual product movement data at a future date and time closest to the current date and time among the individual product movement data including the merchandise code of the scanned barcode.

By providing the reader for reading the wireless tag attached to the merchandise in the shopping basket, for example, on a shopping cart, the individual product recognition unit 33 may recognize the RFID of the newly read wireless tag as the individual product ID of the merchandise purchased by the shopper from the merchandise shelf 80, and may recognize the RFID of the wireless tag that is no longer read after the return operation as the individual product ID of the merchandise returned to the merchandise shelf 80 by the shopper.

The settlement processing unit 34 executes processing for settling a transaction with the shopper based on the data of the purchase list. A settlement method is not particularly limited. An existing settlement method such as cash settlement, credit card settlement, electronic money settlement, and code settlement can be used as it is.

The clock unit 35 tracks the date and time. The individual product recognition unit 33 sets the date and time clocked by the clock unit 35 as the current date and time.

The first communication unit 36 is connected to the communication network 60. The first communication unit 36 performs the data communication with another device connected to the communication network 60 in accordance with the predetermined communication protocol.

The second communication unit 37 is connected to the access point. The second communication unit 37 performs wireless communication with the user terminal 70 via the access point.

The storage unit 38 includes a nonvolatile memory area and a volatile memory area. The storage unit 38 stores a control program for controlling the operation of the transaction processing device 30 in the nonvolatile memory area. The storage unit 38 stores data necessary for operating as the transaction processing device 30 in the volatile memory area. The nonvolatile memory area is, for example, the ROM. The volatile memory area is, for example, the RAM.

The control unit 39 controls the registration processing unit 31, the return processing unit 32, the settlement processing unit 34, the clock unit 35, the first communication unit 36, the second communication unit 37, and the storage unit 38 in accordance with the control program. The control unit 39 mainly includes a processor. The processor is, for example, the CPU.

The transaction processing device 30 sets a part of the volatile memory area of the storage unit 38 as the area of a transaction file 381. The transaction file 381 is an area for storing the data of the purchase list for each shopper who performs self-registration by using the user terminal 70.

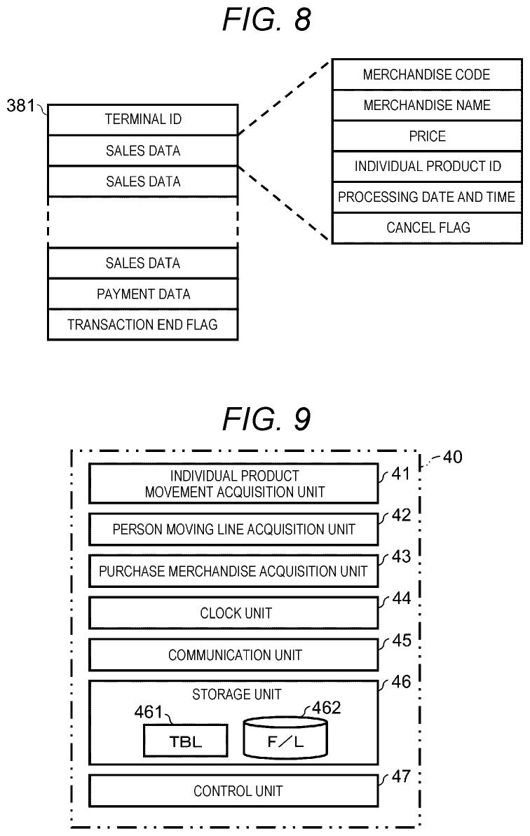

FIG. 8 is a schematic diagram showing main items of data stored in the transaction file 381. The transaction file 381 stores a terminal ID, at least one piece of sales data, payment data, and a transaction end flag. The terminal ID is a unique code set for each user terminal 70 in order to individually identify the user terminal 70. A unique terminal ID is set in the storage unit of each user terminal 70.

The sales data is data including a merchandise code, a merchandise name, a price, an individual product ID, a processing date and time, and a cancel flag. The sales data may include information other than the merchandise code, the merchandise name, the price, the individual product ID, the processing date and time, and the cancel flag. The merchandise code, the merchandise name, and the price are merchandise data set in the merchandise database 51. The individual product ID is the individual product ID recognized by the individual product recognition unit 33. The processing date and time is a date and time clocked by the clock unit 35 at a time point at which the sales data is registered or at a time point at which the sales data is cancelled. The cancel flag is 1-bit data to be set when the sales data is cancelled. The purchase list is created by the sales data in which the cancel flag is in a reset state. The payment data is data of the price used for the settlement of the transaction. For example, in the case of a transaction settled by credit card settlement, a credit payment amount is the payment data. In the case of a transaction settled by electronic money settlement, a payment amount by electronic money is the payment data. The transaction end flag is 1-bit data to be set when the transaction with the shopper who uses the user terminal 70 identified by the terminal ID is settled.

[Description of Individual Product Management Device]

Based on the data processed by the person tracking device 10, the shelf monitoring device 20, and the transaction processing device 30, the individual product management device 40 manages a correspondence relationship between the merchandise displayed and sold on the merchandise shelf 80 and the person related to the movement of the merchandise in units of individual products.

FIG. 9 is a block diagram showing a functional configuration of the individual product management device 40. The individual product management device 40 has functions as an individual product movement acquisition unit 41 (e.g., an individual product movement acquisition device), a person moving line acquisition unit 42 (e.g., a person moving line acquisition device), a purchase merchandise acquisition unit 43 (e.g., a purchase merchandise acquisition device), a clock unit 44 (e.g., a clock), a communication unit 45 (e.g., a communication device), a storage unit 46 (e.g., a storage device, a memory), and a control unit 47 (e.g., a controller).

The individual product movement acquisition unit 41 acquires at least one facing person file 261 to be processed from the shelf monitoring device 20.

The person moving line acquisition unit 42 acquires at least one moving line file 151 to be processed from the person tracking device 10.

The purchase merchandise acquisition unit 43 acquires at least one transaction file 381 to be processed from the transaction processing device 30.

The clock unit 44 tracks the date and time.

The communication unit 45 is connected to the communication network 60. The communication unit 45 performs the data communication with another device connected to the communication network 60 in accordance with the predetermined communication protocol.

The storage unit 46 includes a nonvolatile memory area and a volatile memory area. The storage unit 46 stores a control program for controlling the operation of the individual product management device 40 in the nonvolatile memory area. The storage unit 46 stores data necessary for operating as the individual product management device 40 in the volatile memory area. The nonvolatile memory area is, for example, the ROM. The volatile memory area is, for example, the RAM.

The control unit 47 controls the individual product movement acquisition unit 41, the person moving line acquisition unit 42, the purchase merchandise acquisition unit 43, the clock unit 44, the communication unit 45, and the storage unit 46 in accordance with the control program. The control unit 47 mainly includes a processor. The processor is, for example, the CPU.

The individual product management device 40 sets a part of the volatile memory area of the storage unit 46 as an area of a movement history table 461 and an area of an individual product management file 462.

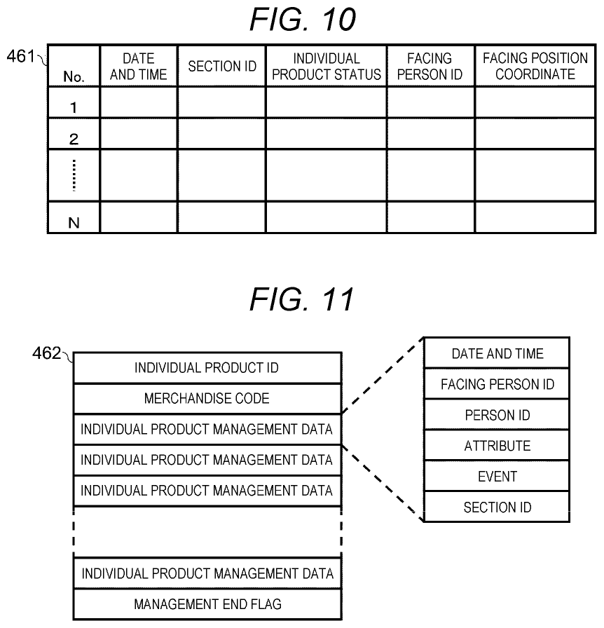

FIG. 10 is a schematic diagram showing a configuration of the movement history table 461. The movement history table 461 has areas for describing a date and time, a section ID, an individual product status, a facing person ID, and a facing position coordinate in an order of a series of table numbers (No.) from “1” to “N”.

FIG. 11 is a schematic diagram showing main items of data stored in the individual product management file 462. The individual product management file 462 stores an individual product ID, a merchandise code, at least one piece of individual product management data, and a management end flag.

The individual product management data includes a date and time, a facing person ID, a person ID, an attribute, an event, and a section ID. The individual product management data may include items other than the date and time, the facing person ID, the person ID, the attribute, the event, and the section ID. The date and time is a date and time when the movement of the merchandise identified by the individual product ID is detected by the movement detection unit 22 of the shelf monitoring device 20. The facing person ID is a facing person ID detected by the facing person detection unit 21 of the shelf monitoring device 20 when the movement of the merchandise is detected at the date and time. The person ID and the attribute are the person ID and the attribute of the moving line file 151 including the person moving line data in which the person status is in the stationary state at the date and time at a place of a position coordinate where the facing position coordinate and an X-Y coordinate of the facing person file 261 including the facing person ID coincide with each other. The event will be described later. The section ID is a section ID detected by the movement detection unit 22 of the shelf monitoring device 20 when the movement of the merchandise is detected at the date and time.

The management end flag is 1-bit data that is set when the individual product identified by the individual product ID is purchased by the shopper or is collected from the store.

[Description of Operation of Store System]

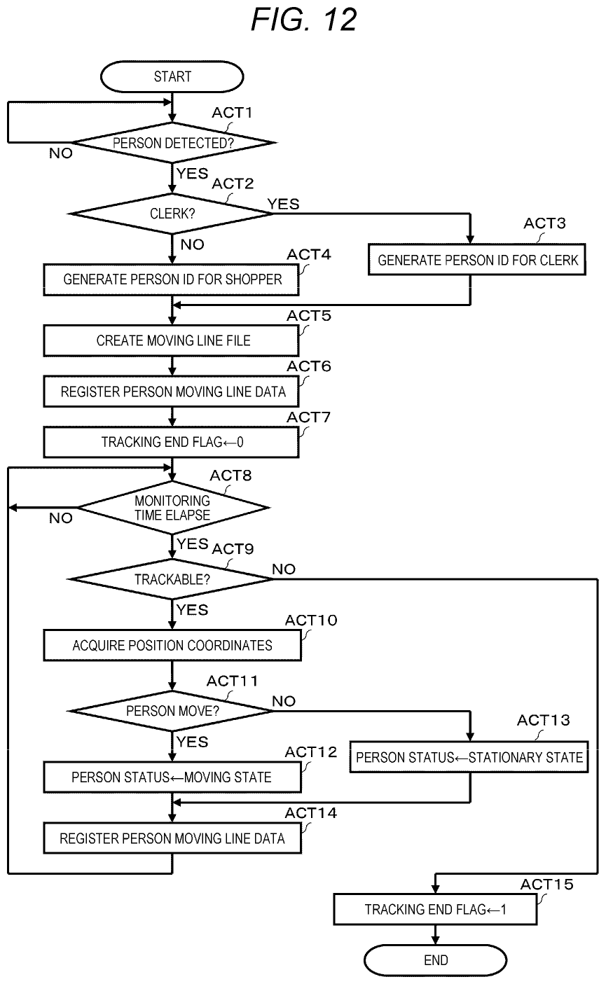

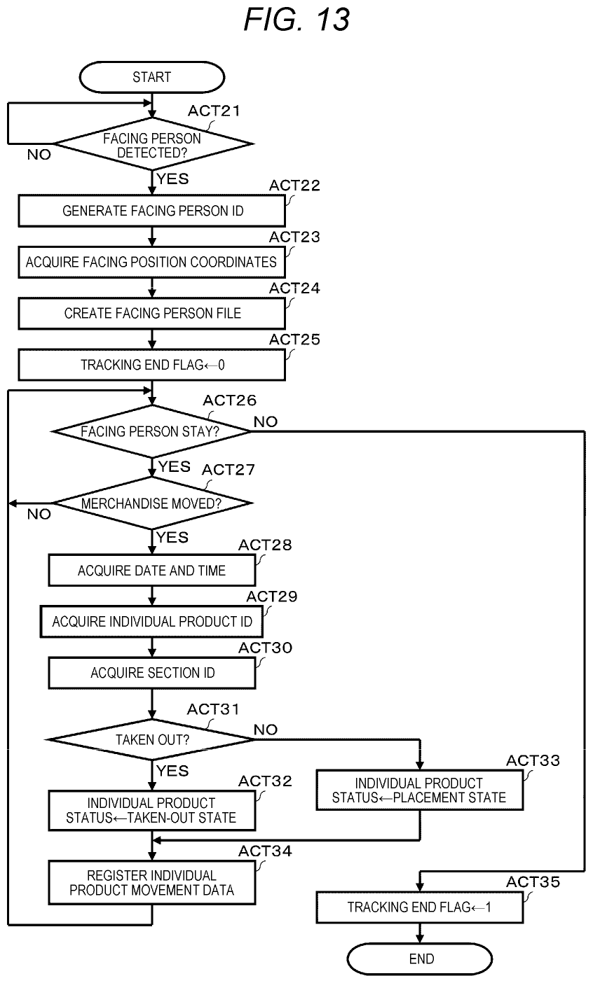

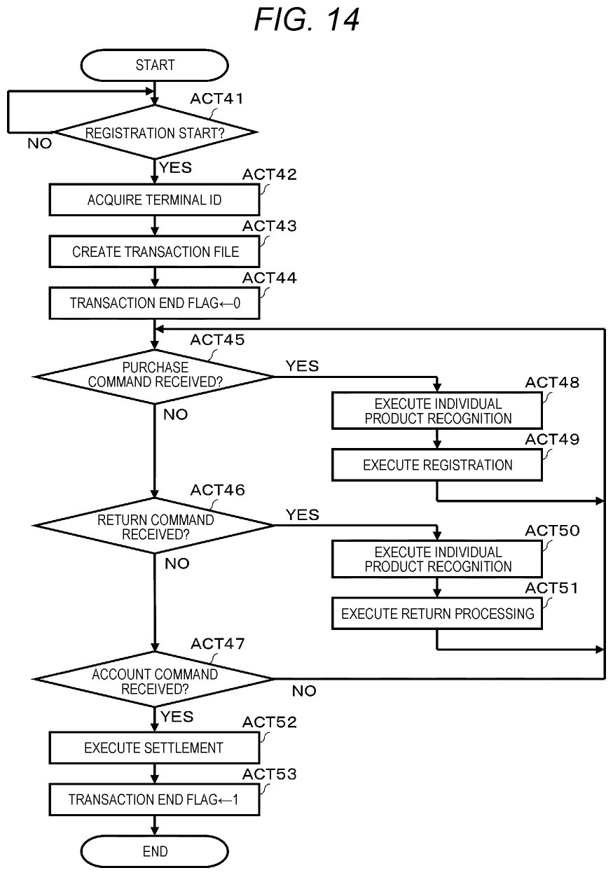

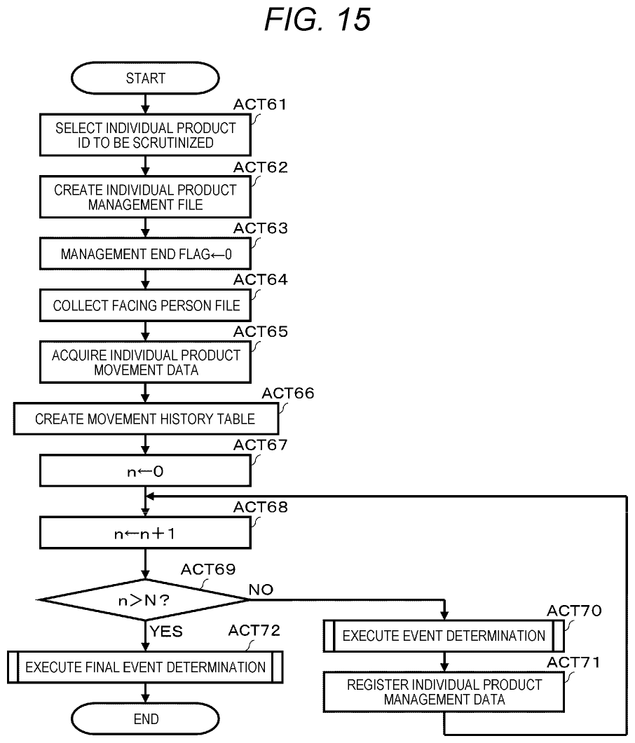

FIG. 12 is a flowchart showing a procedure of the information processing executed by the control unit 16 of the person tracking device 10. FIG. 13 is a flowchart showing a procedure of the information processing executed by the control unit 27 of the shelf monitoring device 20. FIG. 14 is a flowchart showing a procedure of the information processing executed by control unit 39 of the transaction processing device 30. FIGS. 15 to 17 are flowcharts showing a procedure of the information processing executed by the control unit 47 of the individual product management device 40. The procedure of the information processing is not limited to the procedure according to the flowchart. The procedure may be changed as appropriate as long as the same operations and effects can be obtained.

First, the operation of the person tracking device 10 will be described with reference to FIGS. 2, 3, and 12.

In ACT 1, the control unit 16 of the person tracking device 10 waits for a person to be detected by the person detection unit 11. When the shopper or the clerk enters an area which is trackable by the tracking unit 12 in the store, the person detection unit 11 detects the person. The control unit 16 determines YES in ACT 1, and proceeds to ACT 2. In ACT 2, the control unit 16 recognizes an attribute of the person determined by the person detection unit 11.

When the attribute is the clerk, the control unit 16 determines YES in ACT 2, and proceeds to ACT 3. In ACT 3, the control unit 16 generates a person ID for the clerk. For example, the control unit 16 generates a code obtained by combining a symbol “S” and a four-digit number as the person ID for the clerk.

If the attribute is not the clerk, that is, the attribute is the shopper, the control unit 16 determines NO in ACT 2, and proceeds to ACT 4. In ACT 4, the control unit 16 generates a person ID for the shopper. For example, the control unit 16 generates a code obtained by combining a symbol “C” and a four-digit number as the person ID for the shopper.

When the processing in ACT 3 or ACT 4 is completed, the control unit 16 proceeds to ACT 5. In ACT 5, the control unit 16 creates the moving line file 151 in the storage unit 15. That is, when the clerk is detected, the control unit 16 creates the moving line file 151 in which the person ID for the clerk and the attribute indicating the clerk are stored. When the shopper is detected, the control unit 16 creates the moving line file 151 in which the person ID for the shopper and the attribute indicating the shopper are stored. In ACT 6, then, the control unit 16 registers first person moving line data. A date and time of the person moving line data is the current date and time clocked by the clock unit 13. The position coordinates are three-dimensional coordinates calculated by the tracking unit 12 based on a point where the person is detected. The person status is any status. The person status may be a moving state or a stationary state. In ACT 7, the control unit 16 resets the tracking end flag of the moving line file 151 to “0”.

In ACT 8, the control unit 16 waits for a monitoring time to elapse. The monitoring time is a time effective for determining whether the person is moving or stationary. For example, when it is assumed that the person is stationary when it is detected that the person stays at one location for five seconds or more, the monitoring time is set to 5 seconds. When the monitoring time elapses, the control unit 16 determines YES in ACT 8 and proceeds to ACT 9. In ACT 9, the control unit 16 confirms whether the person can be tracked by the tracking unit 12.

When the person can be tracked, the control unit 16 determines YES in ACT 9 and proceeds to ACT 10. In ACT 10, the control unit 16 acquires the position coordinates of the person at a current time point. Then, in ACT 11, the control unit 16 confirms whether the position coordinate matches the position coordinate of the person moving line data registered in the moving line file 151 immediately before. For example, when a length of a line segment connecting the previous position coordinate and the current position coordinate is equal to or less than a predetermined length, the control unit 16 determines that the position coordinates coincide with each other. When the length of the line segment exceeds the predetermined length, the control unit 16 determines that the position coordinates are shifted.

When the position coordinates are shifted, the control unit 16 recognizes that the person is moving. The control unit 16 determines YES in ACT 11 and proceeds to ACT 12. In ACT 12, the control unit 16 sets the person status to the moving state.

When the position coordinates coincide with each other, the control unit 16 recognizes that the person is stationary. The control unit 16 determines NO in ACT 11 and proceeds to ACT 13. In ACT 13, the control unit 16 sets the person status to the stationary state.

When the processing in ACT 12 or ACT 13 is completed, the control unit 16 proceeds to ACT 14. In ACT 14, the control unit 16 registers the person moving line data in the moving line file 151. A date and time of the person moving line data is the current date and time clocked by the clock unit 13. The position coordinates are three-dimensional coordinates calculated by the tracking unit 12 based on a point where the person is detected. The person status is information of the state set in processing in ACT 12 or ACT 13. That is, when it is recognized in ACT 11 that the person is moving, the person status is the moving state. When it is determined in ACT 11 that the person is stationary, the person status is the stationary state.

When the processing in ACT 14 is completed, the control unit 16 returns to ACT 8. That is, the control unit 16 waits for the elapse of the monitoring time. Then, when the monitoring time elapses, the control unit 16 executes the processing in ACT 9 and the subsequent processing in the same manner as described above. Therefore, in the moving line file 151 in which the person ID of the person tracked by the tracking unit 12 is set, the person moving line data is registered every time the monitoring time elapses.

When the tracking unit 12 cannot track the person because the person goes out of the area which is trackable by the tracking unit 12, the control unit 16 determines NO in ACT 9, and proceeds to ACT 15. In ACT 15, the control unit 16 sets the tracking end flag of the moving line file 151 in which the person ID of the person is set to “1”. As described above, the control unit 16 ends the information processing of the procedure shown in the flowchart in FIG. 12.

In this manner, the person tracking device 10 functions as a moving line tracking unit that tracks the moving line of the person who moves in the store by the control unit 16 executing the processing from ACT 1 to ACT 15. With the function, the person tracking device 10 registers the person moving line data related to the person in a time series in the moving line file 151 created for each person. The person moving line data includes the date and time, the position coordinates, and the person status. Therefore, by analyzing the person moving line data by a computer or the like, it is possible to easily obtain information on a person action such as how the person moves in the store with the elapse of time and how much the person stays at which place.

Next, the operation of the shelf monitoring device 20 will be described with reference to FIGS. 4, 5, 6, and 13.

In ACT 21, the control unit 27 of the shelf monitoring device 20 waits for a person facing the merchandise shelf 80 to be detected by the facing person detection unit 21. When one clerk or shopper enters the monitoring target area ARa, the facing person detection unit 21 detects the person. The control unit 27 determines YES in ACT 21 and proceeds to ACT 22. Hereinafter, the person detected by the facing person detection unit 21 will be referred to as a facing person.

In ACT 22, the control unit 27 generates a facing person ID unique to the facing person. The facing person ID is a code obtained by combining any number sequence or characters and numerals that do not overlap with other facing person IDs within at least one business day. In ACT 23, the control unit 27 acquires facing position coordinates. The facing position coordinates are three-dimensional coordinates calculated by the facing person detection unit 21 based on a point where the facing person is detected.

In ACT 24, the control unit 27 creates the facing person file 261 in the storage unit 26. That is, the control unit 16 creates the facing person file 261 in which the facing person ID generated in the processing in ACT 22 and the facing position coordinates acquired in the processing in ACT 23 are stored. In ACT 25, the control unit 16 resets a tracking end flag of the facing person file 261 to “0”.

In ACT 26, the control unit 27 confirms whether the facing person stays in the monitoring target area ARa. When the facing person is detected by the facing person detection unit 21, the control unit 27 determines YES in ACT 26, and proceeds to ACT 27. In ACT 27, the control unit 27 confirms whether the movement of the merchandise is detected by the movement detection unit 22. When the movement of the merchandise is not detected, the control unit 27 determines NO in ACT 27 and returns the processing to ACT 26. Here, in ACT 26 and ACT 27, the control unit 27 waits until the facing person is no longer detected by the facing person detection unit 21 or until the movement of the merchandise is detected by the movement detection unit 22.

In a waiting state in ACT 26 and ACT 27, when the movement of the merchandise is detected by the movement detection unit 22, the control unit 27 determines YES in ACT 27 and proceeds to ACT 28. In ACT 28, the control unit 27 acquires a current date and time clocked by the clock unit 24 as a date and time when the movement of the merchandise is detected by the movement detection unit 22. In ACT 29, the control unit 27 acquires an individual product ID of the merchandise whose movement is detected by the movement detection unit 22. That is, based on the information on the RFID read by the wireless tag reader 94, the control unit 27 acquires the RFID of the wireless tag recognized as being attached to the moving merchandise in the individual product recognition unit 23. Further, in ACT 30, the control unit 27 acquires a section ID of the section in which the movement of the merchandise is detected based on the information on the total weight measured by the weight sensor 92 as the information on the position of the merchandise whose movement is detected by the movement detection unit 22.

In ACT 31, the control unit 27 determines whether the movement of the merchandise is the movement in a taken-out direction or the movement in a placement direction. That is, based on the information on the total weight measured by the weight sensor 92 or the information on the image detected by the camera sensor 93, when it is detected by the movement detection unit 22 that the merchandise is taken out from the merchandise shelf 80, the control unit 27 determines that the movement of the merchandise is the movement in the taken-out direction. When it is detected by the movement detection unit 22 that the merchandise is placed on the merchandise shelf 80 based on the information, the control unit 27 determines the movement of the merchandise is the movement in the placement direction.

When the movement of the merchandise is determined to be the movement in the taken-out direction, the control unit 27 determines YES in ACT 31 and proceeds to ACT 32. In ACT 32, the control unit 27 brings the individual product status into the taken-out state. When the movement of the merchandise is determined to be the movement in the placement direction, the control unit 27 determines NO in ACT 31 and proceeds to ACT 33. In ACT 33, the control unit 27 brings the individual product status into the placement state.

When the processing in ACT 32 or ACT 33 is completed, the control unit 16 proceeds to ACT 34. In ACT 34, the control unit 16 registers the individual product movement data in the facing person file 261. The date and time of the individual product movement data is the date and time acquired in the processing in ACT 28. The individual product ID is the individual product ID acquired in the processing in ACT 29. The merchandise code is a merchandise code stored in the individual product database 52 in association with the individual product ID. The section ID is the section ID acquired in the processing in ACT 30. The individual product status is information on a state set in the processing in ACT 32 or ACT 33. That is, when the taken-out direction is determined in ACT 31, the individual product status is the taken-out state. When the placement direction is determined in ACT 31, the individual product status is the placement state.

When the processing in ACT 34 is completed, the control unit 27 returns the processing to ACT 26. That is, the control unit 27 waits until the facing person is no longer detected by the facing person detection unit 21 or the movement of the merchandise is detected by the movement detection unit 22 again.

In the waiting state, when the movement of the merchandise is detected again by the movement detection unit 22, the control unit 27 executes the processing in ACT 28 and the subsequent processing in the same manner as described above. Therefore, new individual product movement data is registered in the facing person file 261. That is, when the facing person takes the merchandise from the merchandise shelf 80, individual product registration data including the date and time at that time point, the individual product ID which is the RFID of the wireless tag attached to the merchandise, the merchandise code associated with the individual product ID, the section ID of the section where the merchandise is placed, and the individual product status in the taken-out state is registered. When the facing person places the merchandise on the merchandise shelf 80, the individual product registration data including the date and time at that time point, the individual product ID which is the RFID of the wireless tag attached to the merchandise, the merchandise code associated with the individual product ID, the section ID of the section where the merchandise is placed, and the individual product status in the placement state is registered.

In the waiting state in ACT 26 and ACT 27, when the facing person is no longer detected by the facing person detection unit 21, the control unit 27 determines NO in ACT 26, and proceeds to ACT 35. In ACT 35, the control unit 27 sets the tracking end flag of the facing person file 261 to “1”. As described above, the control unit 27 ends the information processing of the procedure shown in the flowchart in FIG. 13.

In this way, the shelf monitoring device 20 functions as a movement detection unit (e.g., the movement detection device) that detects the movement of individual merchandises sold in the store by the control unit 27 executing the processing in ACT 27 in FIG. 13. The shelf monitoring device 20 functions as a date and time acquisition unit (e.g., a date and time acquisition device) that acquires the date and time when the movement of the merchandise is detected by the movement detection unit by the control unit 27 executing the processing in ACT 28 in FIG. 13. Further, the shelf monitoring device 20 functions as a position acquisition unit (e.g., a position acquisition device) that acquires information indicating the position of the merchandise whose movement is detected by the movement detection unit, by the control unit 27 executing the processing in ACT 30 in FIG. 13.

Then, the shelf monitoring device 20 registers the individual product movement data related to the merchandise moved by the facing person in time series in the facing person file 261 created for each facing person. The individual product movement data includes the date and time, the individual product ID, the merchandise code, the section ID, and the individual product status. Therefore, by analyzing individual product moving line data by a computer or the like, it is possible to easily obtain the information on the merchandise movement that indicates which section of merchandise shelf 80 the merchandise taken out by the facing person facing the merchandise shelf 80 belongs to and which section of merchandise shelf 80 the facing person facing the merchandise shelf 80 places the merchandise in as time elapses in units of individual merchandises.

Next, the operation of transaction processing device 30 will be described with reference to FIGS. 7, 8, and 14.

In ACT 41, the control unit 39 of the transaction processing device 30 waits for a command to start registration of the merchandise. When the shopper starts shopping, the shopper operates the user terminal 70 to make it possible to register a purchased merchandise. By such an operation, a registration start command is wirelessly transmitted from the user terminal 70 to the transaction processing device 30. The registration start command includes the terminal ID set in the user terminal 70. When the control unit 39 receives the registration start command, the control unit 39 determines YES in ACT 41 and proceeds to ACT 42. In ACT 42, the control unit 39 acquires the terminal ID from the registration start command. Then, in ACT 43, the control unit 39 creates the transaction file 381 including the terminal ID in the storage unit 38. In ACT 44, the control unit 39 resets a transaction end flag of the transaction file 381 to “0”.

In ACT 45, the control unit 39 confirms whether a purchase command is received from the user terminal 70. When the purchase command is not received, the control unit 39 determines NO in ACT 45 and proceeds to ACT 46. In ACT 46, the control unit 39 confirms whether a return command is received from the user terminal 70. When the return command is not received, the control unit 39 determines NO in ACT 46 and proceeds to ACT 47. In ACT 47, the control unit 39 confirms whether an accounting command is received. When the accounting command is not received, the control unit 39 determines NO in ACT 47 and returns the processing to ACT 45. In this manner, the control unit 39 waits for a command from the user terminal 70 in ACT 45 to ACT 47.

When the shopper scans the barcode attached to the merchandise using a scanning function of the user terminal 70 in order to purchase the merchandise taken out by the shopper from the merchandise shelf 80, the purchase command is transmitted from the user terminal 70. The purchase command includes data on the scanned barcode.

When the control unit 39 receives the purchase command, the control unit 39 determines YES in ACT 45 and proceeds to ACT 48. In ACT 48, the control unit 39 executes individual product recognition processing by controlling the individual product recognition unit 33. Through the processing, the individual product recognition unit 33 recognizes the individual product ID of the merchandise purchased by the shopper from the merchandise shelf 80. In ACT 49, when the individual product ID is recognized, the control unit 39 controls the registration processing unit 31 to execute registration. Through the processing, the registration processing unit 31 generates sales data of the merchandise to which the barcode is attached, and registers the sales data in the transaction file 381. Specifically, the sales data including the merchandise code, the merchandise name and the price, the individual product ID recognized by the individual product recognition unit, the date and time clocked by the clock unit 35 at the current time point, and the cancel flag of the reset state is registered in the transaction file 381. When the registration is completed, the control unit 39 returns to the waiting state in ACT 45 to ACT 47.

In order to return the merchandise once scanned by the shopper, when the barcode attached to the merchandise is scanned after the return operation is performed on the user terminal 70, the return command is transmitted from the user terminal 70. The return command includes data on the scanned barcode.

When the return command is received, the control unit 39 determines YES in ACT 46 and proceeds to ACT 50. In ACT 50, the control unit 39 controls the individual product recognition unit 33 to execute the individual product recognition. Through the processing, the individual product recognition unit 33 recognizes the individual product ID of the merchandise returned to the merchandise shelf 80 by the shopper. In ACT 51, when the individual product ID is recognized, the control unit 39 controls the return processing unit 32 to execute return processing. Through the processing, the return processing unit 32 acquires the sales data on the merchandise to which the barcode is attached from the transaction file 381. Specifically, the cancel flag of the sales data including the individual product ID recognized by the individual product recognition unit 33 is set to “1”. The date and time of the sales data is updated to the date and time clocked by the clock unit 35 at the current time point. When the return processing is completed, the control unit 39 returns to the waiting state in ACT 45 to ACT 47.

When the shopper who completes shopping performs an accounting operation on the user terminal 70, the accounting command is transmitted from the user terminal 70. The accounting command includes payment data.

When the accounting command is received, the control unit 39 determines YES in ACT 47 and proceeds to ACT 52. In ACT 52, the control unit 39 controls the settlement processing unit 34 to execute settlement. Through the processing, the settlement processing unit 34 executes the settlement based on the payment data. For example, when the payment data is a credit payment amount, the settlement of credit card settlement is executed. When the payment data is a payment amount due to electronic money, the settlement of electronic money settlement is executed. When the payment data is a payment amount due to code payment, the settlement of code settlement is executed.

In ACT 53, when the settlement is completed, the control unit 39 sets the transaction end flag of the transaction file 381 to “1”. As described above, the control unit 39 ends the information processing of the procedure shown in the flowchart in FIG. 14.

In this manner, the transaction processing device 30 functions as a registration processing unit (e.g., a registration processor) by the control unit 39 executing the processing in ACT 48 and ACT 49 in FIG. 14. The transaction processing device 30 functions as a return processing unit (e.g., a return processor) by the control unit 39 executing the processing in ACT 50 and ACT 51 in FIG. 14. Further, the transaction processing device 30 functions as a settlement processing unit (e.g., a settlement processor) by the control unit 39 executing the processing in ACT 52 in FIG. 14.

Then, the transaction processing device 30 registers the sales data related to the merchandise purchased by the shopper who is the user of the user terminal 70 in the transaction file 381 created for each user terminal 70. Therefore, by analyzing the sales data by the computer or the like, it is possible to easily obtain the information on the merchandise purchased by the shopper or the returned merchandise together with the processing date and time in units of the individual product identified by the individual product ID.

Next, the operation of the individual product management device 40 will be described with reference to FIGS. 9, 10, 11, 15, 16, and 17.

For example, when a time point clocked by the clock unit 44 reaches a time point after the store is closed on each business day, the control unit 47 of the individual product management device 40 starts the information processing of the procedure shown in the flowchart in FIG. 15. In ACT 61, the control unit 47 selects an individual product ID to be scrutinized. For example, the control unit 47 selects, according to a predetermined rule, any individual product ID from a list of individual product IDs stored in the individual product database 52 as the individual product ID to be scrutinized. At this time, the control unit 47 may select a plurality of individual product IDs. In this case, the control unit 47 repeatedly executes ACT 62 to ACT 71 to be described later for each individual product ID. A method of selecting the individual product ID to be scrutinized is not limited to the method described above. In short, it is sufficient that the individual product ID to be scrutinized can be automatically or artificially selected.

In ACT 62, when the individual product ID to be scrutinized is acquired, the control unit 47 creates the individual product management file 462 including the individual product ID to be scrutinized in the storage unit 46. Then, in ACT 63, the control unit 47 resets a management end flag of the individual product management file 462 to “0”.

In ACT 64, the control unit 47 controls the individual product movement acquisition unit 41, and collects, from the shelf monitoring device 20, the facing person file 261 in which the individual product movement data including the individual product ID to be scrutinized is registered. In ACT 65, the control unit 47 acquires the individual product movement data including the individual product ID to be scrutinized from the collected facing person file 261. Then, in ACT 66, the control unit 47 creates the movement history table 461. Specifically, the control unit 47 creates the movement history table 461 in which the date and time, the section ID, and the individual product status of the individual product movement data and the facing person ID and facing position information of the facing person file 261 including the individual product movement data are arranged in ascending order of the date and time from the table number No.=1.

In ACT 67, the control unit 47 initializes a number counter n to “0”. Next, in ACT 68, the control unit 47 counts up the number counter n by “1”. Then, in ACT 69, the control unit 47 confirms whether the number counter n exceeds a maximum value N of the table number No. in the movement history table 461.

When the number counter n does not exceed the maximum value N, the control unit 47 determines NO in ACT 69 and proceeds to ACT 70. In ACT 70, the control unit 47 executes event determination.

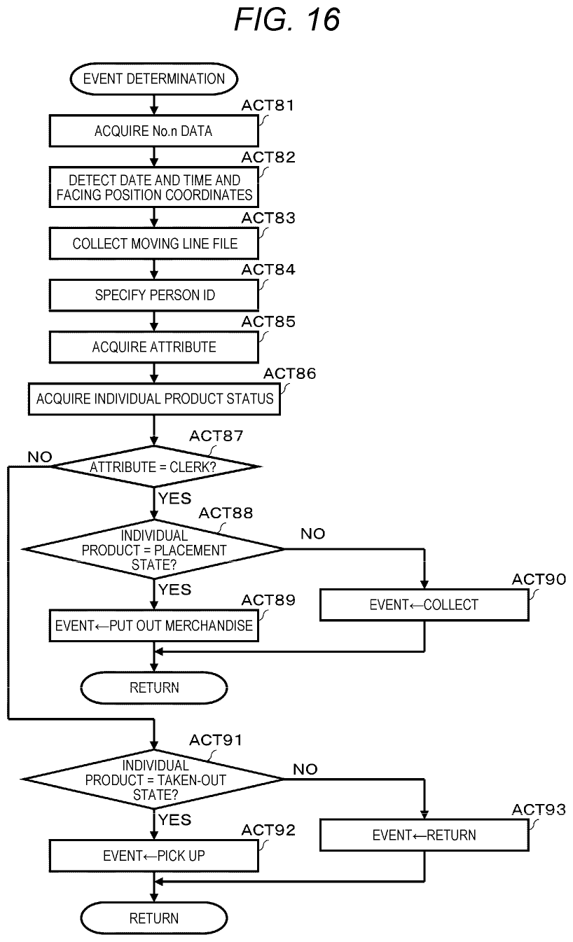

FIG. 16 is a flowchart showing a main procedure of the event determination. In ACT 81, when the event determination is started, the control unit 47 acquires data (date and time, section ID, individual product status, facing person ID, and facing position coordinate) having the number counter n as the table number No. from the movement history table 461. Hereinafter, for convenience of description, the data on the table number No.=n acquired from the movement history table 461 will be referred to as number n data.

In ACT 82, the control unit 47 detects the date and time and the facing position coordinate from the number n data. Then, in ACT 83, the control unit 47 controls the person moving line acquisition unit 42 to acquire, from the person tracking device 10, the moving line file 151 including the person moving line data in which the position coordinates match the facing position coordinates detected from the No. n data and the person status is the stationary state immediately after the date and time when the date and time is detected from the number n data.

In ACT 84, the control unit 47 specifies the person ID of the moving line file 151 acquired from the person tracking device 10 as the person ID of the person identified by the facing person ID of the number n data. In ACT 85, the control unit 47 acquires an attribute from the moving line file 151. Further, in ACT 86, the control unit 47 acquires the individual product status from the number n data.

In ACT 87, the control unit 47 confirms whether the attribute acquired from the moving line file 151 indicates the clerk. When the attribute indicates the clerk, the control unit 47 determines YES in ACT 87, and proceeds to ACT 88. In ACT 88, the control unit 47 determines whether the individual product status acquired from the number n data indicates the placement state. When the individual product status indicates the placement state, it is assumed that the merchandise specified by the number n data is moved when the clerk puts out the merchandise on the merchandise shelf 80. In ACT 88, the control unit 47 determines YES in and proceeds to ACT 89. In ACT 89, the control unit 47 determines that the event is “put out merchandise”.

When the individual product status indicates the taken-out state, it is assumed that the merchandise specified by the number n data is moved when the clerk collects the merchandise from the merchandise shelf 80. The control unit 47 determines NO in ACT 88 and proceeds to ACT 90. In ACT 90, the control unit 47 determines that the event is “collect”.

On the other hand, when the attribute acquired from the moving line file 151 indicates the shopper, the control unit 47 determines NO in ACT 87 and proceeds to ACT 91. In ACT 91, the control unit 47 determines whether the individual product status acquired from the number n data indicates the taken-out state. When the individual product status indicates the taken-out state, it is assumed that the merchandise specified by the number n data is moved when the shopper takes the merchandise from the merchandise shelf 80. The control unit 47 determines YES in ACT 91 and proceeds to ACT 92. In ACT 92, the control unit 47 determines that the event is “pick up”.

When the individual product status indicates the placement state, it is assumed that the merchandise specified by the number n data is moved when the merchandise taken out from the merchandise shelf 80 by the shopper is returned. The control unit 47 determines NO in ACT 91 and proceeds to ACT 93. In ACT 93, the control unit 47 determines that the event is “return”.

When the event is determined in ACT 89, ACT 90, ACT 92, or ACT 93, the control unit 47 ends the event determination and proceeds to ACT 71 in FIG. 15. In ACT 71, the control unit 47 registers the individual product management data in the individual product management file 462. In the individual product management data, the date and time, the section ID, and the facing person ID are the date and time, the section ID, and the facing person ID of the number n data. The person ID is the person ID specified in the processing in ACT 84 in FIG. 16. The attribute is the attribute acquired in the processing in ACT 85 in FIG. 16. The event is an event determined in ACT 89, ACT 90, ACT 92, or ACT 93 in FIG. 16.

The control unit 47 registering the individual product management data in the individual product management file 462 returns the processing to ACT 68. That is, the control unit 47 increments the number counter n by “1”. Then, the control unit 47 executes the processing in ACT 69 and the subsequent processing in the same manner as described above. Therefore, the control unit 47 repeatedly executes the processing in ACT 70 and ACT 71 until the number counter n reaches the maximum value N, that is, the processing of determining the event associated with the movement of the merchandise by the clerk or the shopper and registering the individual product management data including the event in the individual product management file 462.

When the number counter n reaches the maximum value N, the control unit 47 determines YES in ACT 69 and proceeds to ACT 72. In ACT 72, the control unit 47 executes final event determination.

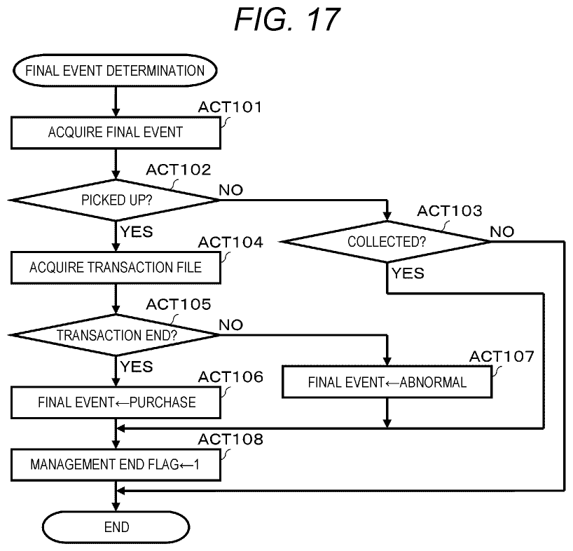

FIG. 17 is a flowchart showing a main procedure of the final event determination. When the final event determination is started, the control unit 47 acquires, based on the number n data when the number counter n is the maximum value N in ACT 101, an event of the individual product management data finally registered in the individual product management file 462. Hereinafter, the event is referred to as a final event.

In ACT 102, the control unit 47 confirms whether the final event is “pick up”. When the final event is not “pick up”, the control unit 47 determines NO in ACT 102, and proceeds to ACT 103. In ACT 103, the control unit 47 confirms whether the final event is “collect”. When the final event is not “collect”, the control unit 47 determines NO in ACT 103 and ends the final event determination.

When the final event is not “pick up” or “collect”, that is, in the case of “put out merchandise” or “return”, the merchandise to which the wireless tag having the individual product ID of the individual product management file 462 including the individual product management data as the RFID is attached is displayed on the merchandise shelf 80. Therefore, the final event maintains the current state.

On the other hand, when the final event is “pick up”, the control unit 47 determines YES in ACT 102, and proceeds to ACT 104. In ACT 104, the control unit 47 controls the purchase merchandise acquisition unit 43 to acquire the transaction file 381 in which the sales data including the individual product ID of the individual product management file 462 in which the individual product management data is registered is registered.

If the corresponding transaction file 381 is acquired from the transaction processing device 30, in ACT 105, the control unit 47 checks the transaction end flag of the transaction file 381. When the transaction end flag is set to “1”, the shopper managed by the transaction file 381 completes the settlement of the transaction. That is, the merchandise to which the wireless tag having the individual product ID of the individual product management file 462 in which the individual product management data is registered is attached is purchased by the shopper. In this case, the control unit 47 determines YES in ACT 105 and proceeds to ACT 106. In ACT 106, the control unit 47 changes the final event to “purchase”.

When the transaction end flag is not set to “1”, the shopper managed by the transaction file 381 does not complete the settlement of the transaction. In other words, it is assumed that the merchandise to which the wireless tag having the individual product ID of the individual product management file 462 in which the individual product management data is registered is attached is brought out without being settled by the shopper. In this case, the control unit 47 determines NO in ACT 105 and proceeds to ACT 107. In ACT 107, the control unit 47 changes the final event to “abnormal”.

After completing the processing in ACT 106 or ACT 107, the control unit 47 proceeds to ACT 108. In ACT 108, the control unit 47 sets the management end flag of the individual product management file 462 in which the individual product management data is registered to “1”.

On the other hand, when the final event is “collect”, the control unit 47 determines YES in ACT 103, and proceeds to ACT 108. In ACT 108, the control unit 47 sets the management end flag of the individual product management file 462 in which the individual product management data is registered to “1”.

Thus, the control unit 47 ends the final event determination. When the final event determination ends, the control unit 47 ends the information processing of the procedure shown in FIG. 15.

In this manner, the individual product management device 40 functions as a person specifying unit (e.g., a person specifying device) that specifies the person related to the movement of the merchandise whose movement is detected by the movement detection unit by the control unit 47 executing the processing in ACT 82 to ACT 84. Specifically, the control unit 47 specifies the person related to the movement of the merchandise based on the movement line of each person tracked by the moving line tracking unit. More specifically, the control unit specifies the person having the moving line in the stationary state at the time when the movement of the merchandise is detected from among movement lines of persons at the time point where the movement of the merchandise is detected.

The individual product management device 40 functions as an event determination unit (e.g., an event determination device) that determines an event associated with the movement detected by the movement detection unit by the control unit 47 executing the processing in ACT 85 to ACT 93. Specifically, the control unit 47 determines an event based on the attribute of the person specified by the person specifying unit. More specifically, the control unit 47 determines an event based on the attribute of the person specified by the person specifying unit and the moving direction of the merchandise whose movement is detected by the movement detection unit.

Further, the individual product management device 40 functions as a storage unit (e.g., a storage device, a memory) that stores the individual product management data in which the date and time acquired by the date and time acquisition unit and the information on the person specified as the movement detected at the date and time by the person specifying unit are associated with each other for each merchandise by the control unit 47 executing the processing in ACT 67 to ACT 72 in cooperation with the storage unit 46. Specifically, the control unit 47 stores the individual product management data in which the information on the event determined by the event determination unit is associated with the date and time and the information on the person described above for each merchandise. More specifically, the control unit 47 stores the information on the position acquired by the position acquisition unit, that is, the individual product management data associated with the section ID, in association with the date and time and the information on the person, for each merchandise.

The individual product management device 40 registers the individual product management data related to the individual product in a time series in the individual product management file 462 created for each individual product of the merchandise. As described above, the individual product management data associates the date and time when the merchandise moves with the information on the person specified as related to the movement. Therefore, by analyzing the individual product management data by the computer, it is possible to easily obtain the time point at which the merchandise is placed on the merchandise shelf 80 for each individual product, the time point at which the merchandise is taken out from the merchandise shelf, and the information on the person based on the movement. From the pieces of information, it is possible to easily analyze as to whether there is a history that a person takes each merchandise, how many times the person takes the merchandise when there is the history, and whether the person who takes the merchandise is a shopper or a clerk.

The event related to the movement of the merchandise can be grasped based on the information on the event stored in association with the time point and the information on the person. Specifically, when the clerk puts out the merchandise to the merchandise shelf 80, an event called “put out merchandise” is included in the individual product management data. When the clerk collects the merchandise from the merchandise shelf 80, an event called “collect” is included in the individual product management data. When the shopper picks up the merchandise from the merchandise shelf, an event called “pick up” is included in the individual product management data. When the merchandise temporarily picked up by the shopper is returned to the merchandise shelf, an event called “return” is included in the individual product management data. Therefore, based on the information on the event, it is possible to easily know whether the movement of the merchandise related to the event is the movement related to the putting out of the merchandise, the movement related to the collection, the movement related to the picking up, or the movement related to the return.

Further, by the information on the position stored in association with the time point and the information on the person, the place where the movement of the merchandise occurs, that is, the section of the merchandise shelf 80 can be grasped. Therefore, when the merchandise picked up by the shopper is returned, the merchandise may be returned to a place different from the original place, but it is possible to easily grasp the occurrence of such an event.

Further, when the event of the individual product management data finally registered in the individual product management file 462, that is, the final event is “pick up”, the individual product management device 40 determines, based on the information on the transaction file 381 managed by the transaction processing device 30, whether the merchandise managed by the individual product management data is purchased by the shopper. When the merchandise is purchased, the individual product management device 40 sets the final event to “purchase”. However, when the merchandise is not purchased, the individual product management device 40 sets the final event to “abnormal”. Therefore, by verifying the event of the individual product management data finally registered in the individual product management file 462, it is possible to easily recognize whether the individual product is shoplifted.

Although at least one embodiment of the store system 100 has been described above, at least one embodiment is not limited thereto.

In at least one embodiment, the store system 100 constructed in a store of a self-registration method using the user terminal 70 is exemplified. The store system 100 is not necessarily limited to a system in the store of the self-registration method using the user terminal 70. For example, even in a store in which the merchandise purchased by the shopper is registered in a point of sales (POS) terminal by a clerk or a self in a checkout field called a cash register or the like, an effect similar to that of at least one embodiment can be obtained by having a function of collectively reading a wireless tag attached to the merchandise at the time of registration in the POS terminal.

In at least one embodiment, it is assumed that the barcode representing the merchandise code is attached to each merchandise. However, the barcode may not be attached to a part of merchandises such as perishable foods. In such a case, for example, a function of displaying a list of non-barcode merchandises is provided in the user terminal 70, and when the merchandise is selected from the list, information on the selected merchandise is transmitted from the user terminal 70 to the transaction processing device, and registration is performed.

In the at least one described embodiment, the individual product data is collectively stored in the individual product database 52. As another embodiment, data set in the individual product database 52 such as the merchandise code in addition to the RFID as the individual product ID is stored in the wireless tag attached to each individual product. In this way, the individual product database 52 can be eliminated.

In at least one embodiment, the attributes of the person are the shopper and the clerk. For example, for the shopper, a customer category such as sex and age may be included in the attribute. Such an attribute can be obtained by, for example, analyzing an image obtained by capturing an image of the shopper. For the clerk, for example, employment forms such as a store manager, a regular employee, and a part-time worker may be included in the attribute. Such an attribute can be obtained, for example, by including identification information of the employment form in a beacon signal emitted from a name plate possessed by each store clerk, and providing a receiver of the beacon signal on the merchandise shelf.

In at least one described embodiment, the facing person detection unit 21 generates any facing person ID. In this regard, the facing person detection unit 21 may set the person ID of the moving line file 151 including the person moving line data in the stationary state at the position coordinates matching the facing position coordinates within a predetermined time after the facing person is detected as the facing person ID.

In at least one embodiment described above, the store system 100 in which the person tracking device 10 has a function as the moving line tracking unit, the shelf monitoring device 20 has the functions as the movement detection unit, the date and time acquisition unit, and the position acquisition unit, and the individual product management device 40 has the functions as the person specifying unit, the storage unit, and the event determination unit is illustrated. For example, the function as the movement detection unit, the function as the date and time acquisition unit, the function as the person specifying unit, and the function as the storage unit may be implemented by one computer device. In other words, by providing a program capable of causing one computer to function as the movement detection unit, the date and time acquisition unit, the person specifying unit, and the storage unit, it is possible to obtain a store system that can achieve the same effect as at least one described embodiment.

Furthermore, the above described one computer device may have a function as the event determination unit. Alternatively, the computer device may have functions as the position acquisition unit and the moving line tracking unit.

In addition, although several embodiments have been described, these embodiments are presented by way of examples only and are not intended to limit scopes of the embodiments. These novel embodiments described herein can be implemented in other various forms, and various omissions, replacements, and changes can be made without departing from the spirit of the disclosure. The accompanying claims and their equivalents are intended to cover such forms or modifications as would fall within the scope of the disclosure.

What is claimed is:

1. A store system comprising:
a movement detection device configured to detect movement of merchandise sold in a store;
a date and time acquisition device configured to acquire a date and time in response to the movement detection device detecting the movement of the merchandise;
a person specifying device configured to determine a person related to the movement of the merchandise detected by the movement detection device; and
a memory configured to store the date and time acquired by the date and time acquisition device and information on the person determined as the movement detected at the date and time by the person specifying device in association with each other.

2. The system of claim 1, further comprising:
an event determination device configured to determine an event associated with the movement detected by the movement detection device, wherein
the memory is configured to store information on the event determined by the event determination device in association with the date and time and the information on the person for the merchandise.

3. The system of claim 2, wherein
the event determination device is configured to determine an event based on an attribute of the person determined by the person specifying device.

4. The system of claim 1, further comprising:
a position acquisition device configured to acquire information indicating a position of the merchandise whose movement is detected by the movement detection device, wherein
the memory is configured to store the information on the position acquired by the position acquisition device in association with the date and time and the information on the person for the merchandise.

5. The system of claim 1, further comprising:
a moving line tracking device configured to track a moving line of the person moving in the store, wherein
the person specifying device is configured to determine the person related to the movement of the merchandise based on the moving line of each person tracked by the moving line tracking device.

6. A method comprising:
detecting movement of individual merchandise sold in a store;
determining a person related to the movement of the merchandise whose movement is detected;
acquiring a date and time when the movement of the merchandise is detected; and
storing, for the individual merchandise, the date and time acquired and information on the determined person as the movement detected at the date and time in association with each other.

7. The method of claim 6, further comprising:
determining an event associated with the movement detected; and
storing, in the memory, information on the event determined in association with the date and time and the information on the person for the individual merchandise.

8. The method of claim 7, further comprising determining an event based on an attribute of the determined person.

9. The method of claim 6, further comprising:
acquiring information indicating a position of the merchandise whose movement is detected; and
storing, in the memory, the information on the position acquired in association with the date and time and the information on the person for the individual merchandise.

10. The method of claim 6, further comprising:
tracking a moving line of the person moving in the store; and
determining the person related to the movement of the merchandise based on the moving line of each person tracked.
